(19) United States
(12) Patent Application Publication
(10) Pub. No.: US 2025/0020891 A1
(43) Pub. Date: Jan. 16, 2025

(54) LENS STRUCTURE, PHOTOGRAPHIC DEVICE AND FOCUSING METHOD OF LENS

(71) Applicant: ZHONGSHAN UNION OPTECH RESEARCH INSTITUTE CO., LTD., Zhongshan (CN)

(72) Inventors: Junqiang GONG, Zhongshan (CN); Kun LI, Zhongshan (CN); Shengping QIU, Zhongshan (CN); Mingzhi XIAO, Zhongshan (CN); Yang WU, Zhongshan (CN); Decan LIU, Zhongshan (CN); Suijing TAN, Zhongshan (CN); Gengguang LU, Zhongshan (CN)

(73) Assignee: ZHONGSHAN UNION OPTECH RESEARCH INSTITUTE CO., LTD., Zhongshan (CN)

(21) Appl. No.: 18/417,260

(22) Filed: Jan. 19, 2024

(30) Foreign Application Priority Data
Jul. 13, 2023 (CN) 202310864414.8

(51) Int. Cl. G02B 7/28; G02B 7/04

(52) U.S. Cl. CPC G02B 7/28; G02B 7/04

(57) ABSTRACT

Disclosed are a lens structure, a photographic device and a focusing method of lens. The lens structure includes a lens barrel, a lens assembly, a drive mechanism, a position detection device and a control device. The lens barrel is extended along a first direction. The lens assembly includes a lens group configured to be movable along the first direction. The drive mechanism is fixedly connected to the lens group and configured to drive the lens group to move along the first direction. The position detection device configured to detect a position of the lens group in real time. The control device is electrically connected to the position detection device and the drive mechanism, and is configured to control the drive mechanism to work according to the position detection device to adjust the position of the lens group.

### CROSS-REFERENCE TO RELATED APPLICATIONS

This application claims priority to Chinese Patent Application No. 202310864414.8, filed on Jul. 13, 2023, the entire contents of which are incorporated herein by reference.

### TECHNICAL FIELD

The present application relates to the technical field of focusing, and in particular to a lens structure, a photographic device and a focusing method of lens.

### BACKGROUND

In the related art, a conventional security zoom lens generally uses a stepping motor and a screw for transmission to achieve zooming and focusing functions and uses optocoupler switch as the initial position sensor. The disadvantage is that this control system is an open-loop system, which purely relies on the precision of its components; when a step loss problem occurs during the process, the lens will have a blurred image problem. Therefore, the motor basically can only be controlled maintaining a relatively low rotational speed. In addition, with the frictional wear of the mechanical system, the product precision will decrease, which will also cause the entire product to fail in application and problems such as blurred images and dropped frames. Therefore, in the lens of the relate art, there exists problems that the rotational speed of the drive motor is low, the adjustment speed of lens is low, and short service life of the drive mechanism.

### SUMMARY

A main objective of the present application is to provide a lens structure, aiming to solve problems existing in the conventional lens structure that the rotational speed of the drive motor is low, the adjustment speed of lens is low, and short service life of the drive mechanism.

To achieve the above objective, the present application provides a lens structure, which includes a lens barrel extending along a first direction, a lens assembly, a drive mechanism, a position detection device and a control device. The lens assembly includes a lens group configured to be movable along the first direction. The drive mechanism is fixedly connected to the lens group and configured to drive the lens group to move along the first direction. The position detection device is configured to detect a position of the lens group in real time. The control device is electrically connected to the position detection device and the drive mechanism, and is configured to control the drive mechanism to work according to the position detection device to adjust the position of the lens group.

In some embodiments, the position detection device includes a magnetic grating sensor or an optical grating sensor.

In some embodiments, the magnetic grating sensor includes a magnetic head and a magnetic grating. The magnetic grating is extended along the first direction, and the magnetic head is configured to be movable along the first direction and is fixedly connected to the lens group.

In some embodiments, the optical grating sensor includes a ruler grating and an indicator grating. The ruler grating is extended along the first direction, and the indicator grating is configured to be movable along the first direction and is fixedly connected to the lens group.

In some embodiments, the drive mechanism includes a drive motor, a screw and a drive nut. The drive motor is provided with an output shaft extending along the first direction. The screw is extended along the first direction and coaxially connected to the output shaft. The drive nut is sleeved on a periphery of the screw and fixedly connected to the lens group to drive the lens group to move along the first direction. The control device is electrically connected to the drive motor to control the drive motor to work.

In some embodiments, the lens structure further includes a limit switch and a triggering member. One of the limit switch and the triggering member is fixedly provided on the lens barrel, and the other of the limit switch and the triggering member is fixedly connected to the lens group. The control device is electrically connected to the limit switch and configured to control the drive motor to work according to the limit switch.

In some embodiments, the lens assembly includes multiple lens groups arranged at intervals in the first direction; multiple drive mechanisms and multiple position detection devices are provided, each drive mechanism is configured to drive one lens group to move, and each position detection device is configured to detect a position of one corresponding lens group. The control device is electrically connected to the multiple position detection devices and the multiple drive mechanisms, and is configured to control one corresponding drive mechanism to work according to each position detection device.

The present application further provides a photographic device, which includes a lens structure, and the lens structure includes a lens barrel extending along a first direction, a lens assembly, a drive mechanism, a position detection device and a control device. The lens assembly includes a lens group configured to be movable along the first direction. The drive mechanism is fixedly connected to the lens group and configured to drive the lens group to move along the first direction. The position detection device is configured to detect a position of the lens group in real time. The control device is electrically connected to the position detection device and the drive mechanism, and is configured to control the drive mechanism to work according to the position detection device to adjust the position of the lens group.

The present application further provides a focusing method of lens, which is performed based on the above-mentioned lens structure, and the method includes:
controlling a position detection device to detect position information of a lens group in real time, and obtaining actual position information of the lens group;
comparing the actual position information and target position information to obtain a displacement difference value; and
controlling the drive mechanism to work according to the displacement difference value to adjust the lens group to the target position.

In some embodiments, before the controlling the position detection device to detect the position information of the lens group in real time, and obtaining the actual position information of the lens group, the method includes:
obtaining the target position information; and
controlling the drive mechanism to drive the lens group to move from an initial position to the target position.

In this technical solution of the present application, the position detection device adopts closed-loop control, which can detect the position of the lens group (zoom group/compensation group) in real time during the travel of the lens group moving along the first direction. Besides, the control device adjusts the position of the lens group in real time according to the displacement difference between the actual position and the target position of the lens group, which is not limited by the physical precision and wear precision of the drive mechanism itself. Meanwhile, when the drive mechanism drives the lens group to move at high speed, it is not affected by poor stop accuracy, so that the lens group can accurately reach the target position acquired for zooming and focusing, to solve the problems existing in the conventional lens structure that the rotational speed of the drive motor is low, the adjustment speed of the lens is low, and the service life of the drive mechanism is short.

### BRIEF DESCRIPTION OF THE DRAWINGS

In order to more clearly illustrate the technical solutions in the embodiments of the present application or in the related art, drawings that are needed to illustrate the embodiments or the related art are simply introduced below. Obviously, drawings introduced below are just some of the embodiments in the present application. For those of ordinary skill in the art, other figures can be further obtained without creative efforts according to the structures shown in drawings below.

FIG. 1 is a schematic perspective view of a lens structure according to an embodiment of the present application.

FIG. 2 is a schematic perspective view of a part of the structure of the lens structure in

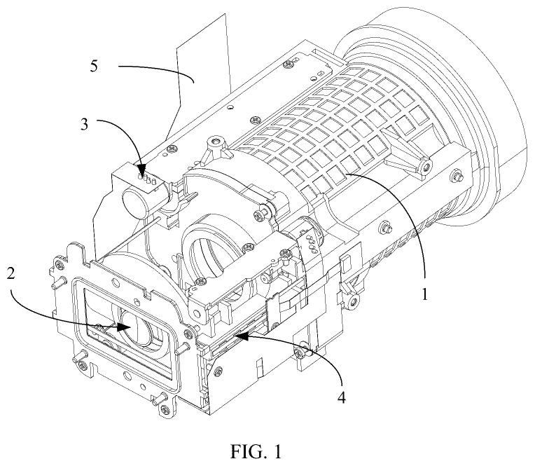

FIG. 1.

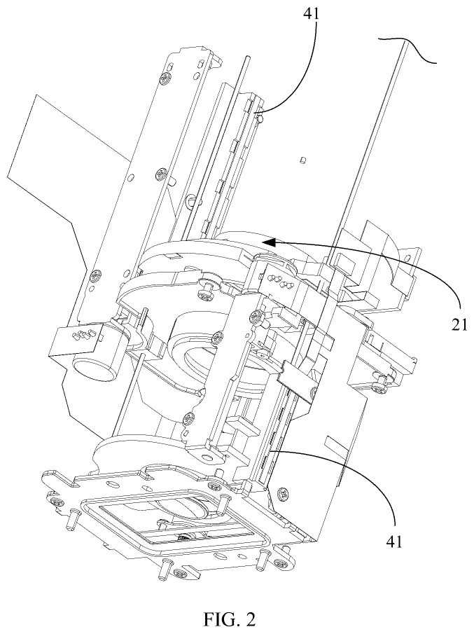

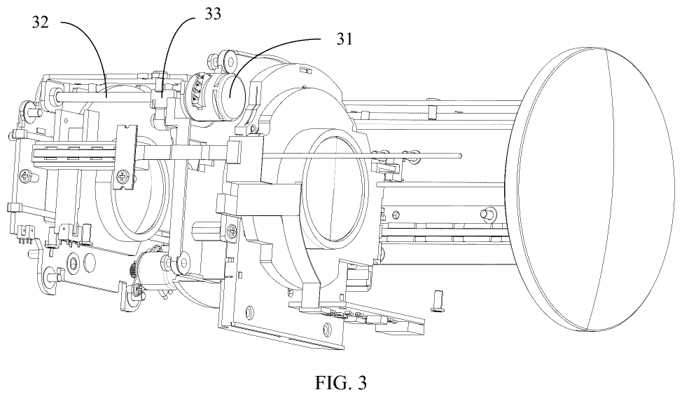

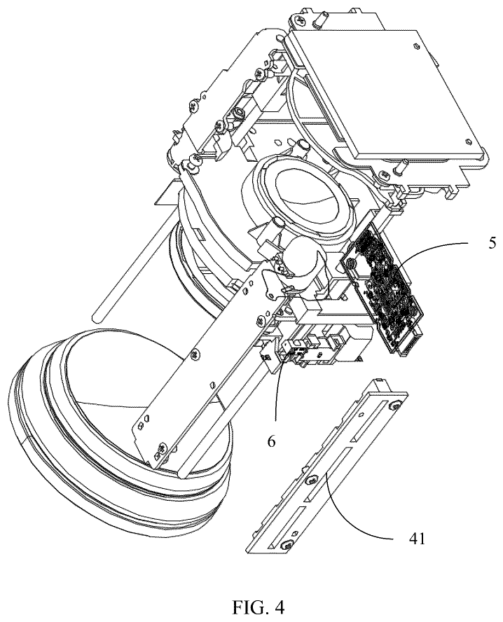

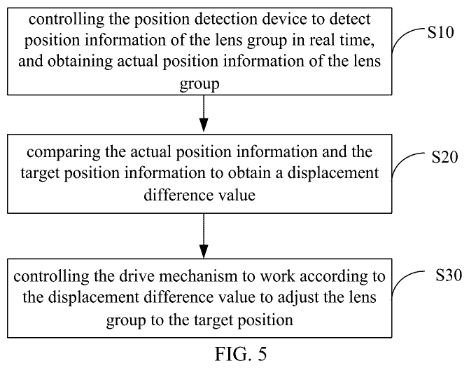

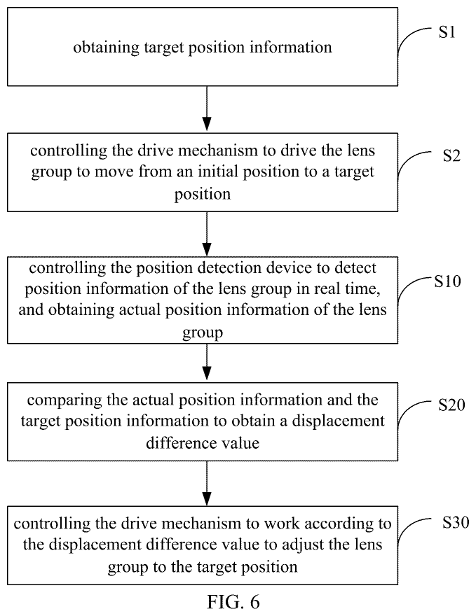

FIG. 3 is another schematic perspective view of the lens structure in FIG. 2.

FIG. 4 is another schematic perspective view of a part of the structure of the lens structure in FIG. 1.

FIG. 5 is a flowchart of a focusing method of lens according to an embodiment of the present application.

FIG. 6 is a flowchart of a focusing method of lens according to another embodiment of the present application.

The realization of the purpose, the functional feature, and the advantage of present application will be further illustrated referring to the drawings.

### DETAILED DESCRIPTION OF THE EMBODIMENTS

The technical solutions of the embodiments of the present application will be clearly and completely described below in conjunction with the drawings in the embodiments of the present application. It is obvious that the embodiments to be described are only some rather than all the embodiments of the present application. All other embodiments obtained by those of ordinary skill in the art based on the embodiments of the present application without creative efforts should fall within the scope of the present application.

It should be noted that all the directional indications (such as up, down, left, right, front, rear, etc.) in the embodiments of the present application are only used to explain the relative positional relationship, movement, etc. among the components in a certain posture (as shown in the drawings). If the specific posture changes, the directional indication will change accordingly.

Besides, the descriptions associated with “first”, “second”, etc. in the present application are merely for descriptive purposes, and cannot be understood as indicating or suggesting the relative importance or implicitly indicating the number of the indicated technical feature. Therefore, the features defined with “first” or “second” can expressly or implicitly include at least one such feature. In addition, the meaning of “and/or” appearing in the present application includes three solutions. For example, “A and/or B” includes only A, or only B, or both A and B. Moreover, the technical solutions of the various embodiments can be combined with each other, but the combinations must be based on the realization by those of ordinary skill in the art. When the combination of technical solutions is contradictory or cannot be achieved, it should be considered that such a combination of technical solutions does not exist, nor does it fall within the scope of the present application.

In the related art, a conventional security zoom lens generally uses a stepping motor and a screw for transmission to achieve zooming and focusing functions and uses optocoupler switch as the initial position sensor. The disadvantage is that this control system is an open-loop system, which purely relies on the precision of its components; when a step loss problem occurs during the process, the lens will have a blurred image problem. Therefore, the motor basically can only be controlled maintaining a relatively low rotational speed. In addition, with the frictional wear of the mechanical system, the product precision will decrease, which will also cause the entire product to fail in application and problems such as blurred images and dropped frames. Therefore, in the lens of the relate art, there exists problems that the rotational speed of the drive motor is low, the adjustment speed of lens is low, and short service life of the drive mechanism.

To solve the above problem, the present application provides a lens structure, and FIGS. 1 to 4 are specific embodiments of the lens structure provided by the present application.

Referring to FIGS. 1 to 4, the lens structure 100 includes a lens barrel 1, a lens assembly 2, a drive mechanism 3, a position detection device 4 and a control device 5. The lens barrel is extended in a first direction. The lens assembly 2 includes a lens group 21 configured to be movable along the first direction. The drive mechanism 3 is fixedly connected to the lens group 21 and configured to drive the lens group 21 to move along the first direction. The position detection device 4 is configured to detect the position of the lens group 21 in real time. The control device 5 is electrically connected to the position detection device 4 and the drive mechanism 3, and is configured to control the drive mechanism 3 to work according to the position detection device 4 to adjust the position of the lens group 21.

In this technical solution of the present application, the position detection device 4 adopts closed-loop control, which can detect the position of the lens group 21 (zoom group/compensation group) in real time during the travel of the lens group 21 moving along the first direction. Besides, the control device 5 adjusts the position of the lens group 21 in real time according to the displacement difference between the actual position and the target position of the lens group 21, which is not limited by the physical precision and wear precision of the drive mechanism 3 itself. Meanwhile, when the drive mechanism 3 drives the lens group 21 to move at high speed, it is not affected by poor stop accuracy, so that the lens group 21 can accurately reach the target position acquired for zooming and focusing, to solve the problems existing in the conventional lens structure that the rotational speed of the drive motor is low, the adjustment speed of the lens is low, and the service life of the drive mechanism is short.

It should be noted that, since it is based on that the position detection device 4 provides real-time feedback of position information in a closed-loop manner, the drive mechanism 3 can be driven and controlled at high speed, when the rotational speed is raised, the actual position is balanced by using proportion integral differential (PID) control, which will not be affected by the step loss of the drive mechanism 3 (such as a screw structure). Even when there is a step loss problem, the position detection device 3 can detect the position deviation of the lens group 21 in time, and timely control the drive mechanism 3 to continue working via the control device 5 to adjust the position of the lens group 21, so that the zooming/focusing speed of the lens can be effectively improved.

It should be further noted that, based on the above-mentioned closed-loop control, since the position detection device 4 can provide feedback of position information in real time, even if the drive mechanism 3 has mechanical wear, as long as the system does not crash, it can make its zoom group/compensation group reach the designated target position via the PID control algorithm, thereby greatly prolonging the service life of the lens structure 100.

Specifically, referring to FIG. 2, in an embodiment, the position detection device 4 includes a magnetic grating sensor 41 or an optical grating sensor.

It should be noted that the magnetic grating sensor 41 consists of a magnetic grating, a magnetic head and a detection circuit. The magnetic grating is made by plating a uniform magnetic film on a grating base made of non-magnetic materials, and recording magnetic signal grating strips with equal spacing and alternating positive and negative polarities. The magnetic head has two types: dynamic magnetic head (speed response type magnetic head) and static magnetic head (magnetic flux response type magnetic head). The dynamic magnetic head has an output winding, and only when the magnetic head and the magnetic grating have relative movement can a signal be output. The static magnetic head has two windings of excitation and output, and the signal can also be output even when it is still relative to the magnetic grating. The static magnetic head is a multi-gap iron core with different effective cross-sections formed by stacked iron-nickel alloy sheets. The role of the excitation winding is equivalent to a magnetic switch. When applying alternating current to it, the magnetic circuit with a relative small cross-section of the iron core is excited twice in every cycle to have magnetic saturation, which makes the magnetic lines formed by the magnetic grating cannot pass through the iron core. Only when the excitation current crosses zero twice in every cycle, the iron core thus does not have magnetic saturation, and the magnetic lines formed by the magnetic grating can pass through the iron core. At this time, the output winding thus has an induced potential output. Its frequency is twice the frequency of the excitation current, and the amplitude of the output voltage is proportional to the magnetic flux entering the iron core, that is, it is related to the position of the magnetic head relative to the magnetic grating. The magnetic head is made of multiple gaps to increase the output, and its output signal is the average value of the signals obtained by multiple gaps, so that it can improve the output accuracy.

It should be noted that the optical grating sensor refers to a transducer that uses the grating Moiré fringe principle to measure displacement. The optical grating is an optical device that consists of a large number of parallel slits with equal width and equal spacing. The common used optical grating is made by engraving a large number of parallel lines on a glass plate. The engraving is the opaque part, and the smooth part between two engravings can transmit light, which is equivalent to a slit. The refined optical grating has thousands or even ten of thousands of notches within a width of 1 cm. This optical grating that uses transmitted light diffraction is called a transmission grating. The Moiré fringes formed by the optical grating have the effects of optical magnification and averaging error, which can improve the measurement accuracy. An optical grating sensor generally consists of four parts: a ruler grating, an indicator grating, an optical system and a measurement system. When the ruler grating moves relative to the indicator grating, it will form bright and dark Moiré fringes that are roughly distributed sinusoidal. These fringes move at a relative speed of the grating and directly illuminate the photoelectric elements, and a series of electric pulses will be obtained at its output end. The digital signal output is generated by the amplification, shaping, direction recognition and counting system, and directly displays the measured displacement.

Specifically, in an embodiment, the magnetic grating sensor 41 includes a magnetic head and a magnetic grating. The magnetic grating is extended along the first direction, the magnetic head is configured to be movable along the first direction, and the magnetic head is fixedly connected to the lens group 21. In this way, the position of the magnetic head can indirectly reflect the position of the lens group 21, and the actual position of the lens group 21 can be accurately detected by the relative movement between the magnetic head and the magnetic grating.

Specifically, in another embodiment, the optical grating sensor includes a ruler grating and an indicator grating. The ruler grating is extended in the first direction, the indicator grating is configured to be movable along the first direction, and the indicator grating is fixedly connected to the lens group 21. In this way, the position of the indicator grating can indirectly reflect the position of the lens group 21, and the actual position of the lens group 21 can also be accurately detected by the relative movement between the indicator grating and the ruler grating.

Specifically, referring to FIG. 3, in an embodiment, the drive mechanism includes a drive motor 31, a screw 32 and a drive nut 33. The drive motor 31 has an output shaft extending along the first direction. The screw 32 is extended along the first direction and is coaxially connected to the output shaft. The drive nut 33 is sleeved on the periphery of the screw 32, and is fixedly connected to the lens group 21 to drive the lens group 21 to move along the first direction. The control device 5 is electrically connected to the drive motor 31 for controlling the drive motor 31 to work. The drive motor 31 drives the screw 32 to rotate, the rotational travel of the screw 32 is transferred into the movement travel of the drive nut 33 along the first direction by the thread cooperation, and the position of the lens group 21 in the first direction is thus adjusted. When the drive motor 31 works, the screw 32 rotates, and the drive nut 33 drives the lens group to move. When the drive motor 31 is powered off, the screw 32 stops rotating, and the drive nut 33 stops moving. When the lens group 21 moves to the target position, by controlling the drive motor 31 to power off and stop rotating via the control device 5, the lens group 21 is allowed to stay at the target position.

Specifically, in an embodiment, the lens structure 100 further includes a limit switch 6 and a triggering member. One of the limit switch 6 and the triggering member is fixedly provided on the lens barrel 1, and the other is fixedly connected to the lens group 21. The control device 5 is electrically connected to the limit switch 6 and configured to control the drive motor 31 to work according to the limit switch 6.

It should be noted that the position where the limit switch 6 and the triggering member interact is the position where the lens group is zeroed. By configuring like this, when the triggering member triggers the limit switch 6 to work, the limit switch 6 sends a power-off command to make the drive motor 31 stop working and adjust the lens group to the initial position. It can be understood that the limit switch 6 can be an infrared photoelectric control switch, and the triggering member can be a baffle. When the baffle blocks the infrared light, it indicates that the lens group 21 is in place, and then the limit switch 6 sends a control signal.

Further, during the zooming and focusing process, it generally requires the cooperation of multiple lens groups 21, and each lens group 21 needs to be at its corresponding target position to finally achieve clear imaging. Therefore, in an embodiment, the lens assembly 2 includes multiple lens groups 21 arranged with intervals in the first direction. Multiple lens groups 21 can be configured as zoom groups and compensation groups, etc. In order to drive each lens group 21, there are multiple drive mechanisms 3 and position detection devices 4. Each drive mechanism 3 is configured to drive one lens group 21 to move, and each position detection device 4 is configured to detect the position of one corresponding lens group 21. The control device 5 is electrically connected to the multiple position detection devices 4 and the multiple drive mechanisms 3, and is configured to control one corresponding drive mechanism 3 to work according to each position detection device 4. By configuring like this, each lens group 21 can be driven by one drive mechanism 3, and each drive mechanism 3 works according to one corresponding position detection device 4, so that each lens group 21 can precisely be at the target position.

Specifically, in an embodiment, the control device 5 includes a signal amplifier, which is configured to amplify the signal of the position information detected by the position detection device 4. The signal amplifier adopts an operational amplifier circuit to accurately amplify the detected signal, so as to provide accurate control information.

The present application further provides a photographic device, which includes the above-mentioned lens structure 100, and the specific structure of the lens structure 100 can be referred to the above-mentioned embodiments. Since the lens structure 100 of this photographic device adopts all the technical solutions of all the above-mentioned embodiments, it therefore has at least all the beneficial effects brought by the technical solutions of the above-mentioned embodiments, and there is no need to repeat them here.

Specifically, in an embodiment, the photographic device further includes a monitoring device. When the monitoring works, it needs to be at a high magnification ratio, so it is vital whether the image is clear. This monitoring device adopts the lens structure 100, and since the position detection device 4 adopts closed-loop control and detects the position of the lens group 21 (zoom group/compensation group) in real time to adjust the position of the lens group 21 in real time, so that the monitoring device can achieve clear imaging no matter what magnification ratio it is at.

The present application further provides a focusing method of lens, which is achieved based on the above-mentioned lens structure 100, and the method includes the following steps:

Step S10, controlling the position detection device 4 to detect the position information of the lens group 21 in real time, and obtaining the actual position information of the lens group 21.

It should be noted that when the lens group 21 is driven to move along the first direction by the drive mechanism 3, the position detection device 4 can achieve closed-loop control and detecting the position of the lens group 21 in real time, and can provide feedback of detected position information in real time.

Step S20, comparing the actual position information and the target position information to obtain a displacement difference value.

It should be noted that during the zooming and focusing process, in this optical system, when a corresponding magnification ratio is determined to be achieved, each lens group 21 has its precise target position according to the focal lengths of multiple lenses of the lens group 21, and when each lens group 21 is at its target position, it can finally achieve clear imaging on the image plane. Therefore, by comparing the actual position information and the target position information, the difference between them can be taken, and the displacement value of the lens group 21 can be obtained for providing a numerical basis for the subsequent drive mechanism 3 to drive the lens group 21.

Step S30, controlling the drive mechanism 3 to work according to the displacement difference value to adjust the lens group 21 to the target position.

In this technical solution of the present application, the position detection device 4 adjusts the position of the lens group 21 in real time according to the displacement difference between the actual position and the target position of the lens group 21, which is not restricted by the physical precision and wear precision of the drive mechanism 3 itself, and when the drive mechanism 3 drives the lens group 21 to move at high speed, it is not affected by poor stop precision, which allows the lens group 21 to accurately reach the target position required for zooming or focusing, and solves the problems existing in the conventional lens structure that the rotational speed of the drive motor is low, the adjustment speed of lens is low, and short service life of the drive mechanism.

In an embodiment, before the step S10, controlling the position detection device 4 to detect the position information of the lens group 21 in real time, and obtaining the actual position information of the lens group 21, this method further includes steps:

Step S1, obtaining the target position information.

It should be noted that the target position information is the set position of each lens group 21 when the optical system achieves clear imaging, that is, when each lens group 21 precisely reaches the target position, it can definitely achieve clear imaging.

Step S2, controlling the drive mechanism 3 to drive the lens group 21 to move from an initial position to the target position.

In this technical solution of the present application, a pulse signal is given first according to target position information, and the drive mechanism 3 drives the lens group 21 to move according to the pulse information. When the lens group 21 moves towards the target position, if the drive mechanism 3 has low wear, high stop precision and high physical precision, the lens group 21 will reach the target position; if the drive mechanism 3 has low precision or step loss, the lens group 21 will reach near the target position, and then detecting and adjusting the lens group 21 in real time to make it reach the target position via the position detection device 4.

The above-mentioned are only some embodiments of the present application, and are not intended to limit the scope of the present application. Under the invention concept of the present application, any equivalent structural variation made by using the specification and the content of the drawings of the present application, or direct/indirect application on other related technical fields are all included in the scope of the present application.

What is claimed is:

1. A lens structure, comprising:
a lens barrel extending along a first direction;
a lens assembly comprising a lens group configured to be movable along the first direction;
a drive mechanism fixedly connected to the lens group and configured to drive the lens group to move along the first direction;
a position detection device configured to detect a position of the lens group in real time; and
a control device electrically connected to the position detection device and the drive mechanism and configured to control the drive mechanism to work according to the position detection device to adjust the position of the lens group.

2. The lens structure according to claim 1, wherein the position detection device comprises a magnetic grating sensor or an optical grating sensor.

3. The lens structure according to claim 2, wherein the magnetic grating sensor comprises a magnetic head and a magnetic grating, the magnetic grating is extended along the first direction, and the magnetic head is configured to be movable along the first direction and is fixedly connected to the lens group.

4. The lens structure according to claim 2, wherein the optical grating sensor comprises a ruler grating and an indicator grating, the ruler grating is extended along the first direction, and the indicator grating is configured to be movable along the first direction and is fixedly connected to the lens group.

5. The lens structure according to claim 1, wherein the drive mechanism comprises:
a drive motor provided with an output shaft extending along the first direction;
a screw extending along the first direction and coaxially connected to the output shaft; and
a drive nut sleeved on a periphery of the screw and fixedly connected to the lens group to drive the lens group to move along the first direction;
wherein the control device is electrically connected to the drive motor to control the drive motor to work.

6. The lens structure according to claim 5, further comprising:
a limit switch and a triggering member;
wherein one of the limit switch and the triggering member is fixedly provided on the lens barrel, and the other of the limit switch and the triggering member is fixedly connected to the lens group; and
the control device is electrically connected to the limit switch and configured to control the drive motor to work according to the limit switch.

7. The lens structure according to claim 1, wherein the lens assembly comprises multiple lens groups arranged at intervals in the first direction;
multiple drive mechanisms and multiple position detection devices are provided, each drive mechanism is configured to drive one lens group to move, and each position detection device is configured to detect a position of one corresponding lens group; and
the control device is electrically connected to the multiple position detection devices and the multiple drive mechanisms and is configured to control one corresponding drive mechanism to work according to each position detection device.

8. A photographic device, comprising the lens structure according to claim 1.

9. A focusing method of lens, performed based on the lens structure according to claim 1, comprising:
controlling a position detection device to detect position information of a lens group in real time, and obtaining actual position information of the lens group;
comparing the actual position information and target position information to obtain a displacement difference value; and
controlling the drive mechanism to work according to the displacement difference value to adjust the lens group to the target position.

10. The focusing method of lens according to claim 9, wherein before the controlling the position detection device to detect the position information of the lens group in real time, and obtaining the actual position information of the lens group, the method comprises:
obtaining the target position information; and
controlling the drive mechanism to drive the lens group to move from an initial position to the target position.
